(19) United States
(12) Patent Application Publication
(10) Pub. No.: US 2006/0254435 A1
(43) Pub. Date: Nov. 16, 2006

(54) Arrangement for producing a spun thread

(75) Inventor: Peter Schweier, Geislingen (DE)

Correspondence Address: CROWELL & MORING LLP;INTELLECTUAL PROPERTY GROUP, P.O. BOX 14300, WASHINGTON, DC, 20044-4300, US

(73) Assignee: Maschinenfabrik Rieter AG, Winterthur (CH)

(21) Appl. No.: 11/431,524

(22) Filed: May 11, 2006

(30) Foreign Application Priority Data
May 12, 2005 (DE) 10 2005 022 686.8

(51) Int. Cl. A23B 4/00

(52) U.S. Cl. 99/516

(57) ABSTRACT

An arrangement for producing a spun thread from a staple fiber strand includes a drafting unit and an airjet unit arranged downstream thereof. A vortex chamber including an air evacuation channel is located in the airjet unit. A cleaning channel having a suction opening is arranged to the delivery roller pair of the drafting unit. The air evacuation channel is designed, at least in its primary section, as a ring channel around a stationary spindle-shaped component. The cleaning channel merges with the air evacuation channel, preferably in the inside of the airjet unit, and both are jointly connected to a common vacuum source. The cleaning channel only merges with the air evacuation channel downstream of the ring channel in airstream direction. The cleaning channel can also include a ring-shaped area, which is arranged around the spindle-shaped component.

### BACKGROUND AND SUMMARY OF THE INVENTION

This application claims the priority of German Application No. 10 2005 022 686.8 filed May 12, 2005, the disclosure of which is expressly incorporated by reference herein.

The present invention relates to an arrangement for producing a spun thread from a staple fiber strand, the arrangement comprising a drafting unit having a delivery roller pair, and an airjet unit arranged downstream of the drafting unit, which airjet unit includes a vortex chamber having an air evacuation channel. The arrangement also includes a cleaning channel having a suction opening and arranged toward the delivery roller pair, whereby the air evacuation channel is designed at least in its primary section as a ring channel around a stationary spindle-shaped component, and whereby the cleaning channel merges with the air evacuation channel and both are connected to a common vacuum source.

An arrangement of this type is described in prior art German published patent application 103 11 826. In the case of this arrangement, a staple fiber strand is drafted in the drafting unit to a fiber strand, to which fiber strand the spinning twist is given in the airjet unit. The fiber strand is guided through an entry channel of the airjet unit into a vortex chamber, to which a fluid device for generating a vortex current, around an entry opening of a thread withdrawal channel is arranged. The front ends of the fibers held in the fiber strand are initially guided into the thread withdrawal channel, while the rear free fiber ends spread out, are seized by the vortex current and are twined around the bound front ends already located in the entry opening of the thread withdrawal channel, whereby a thread is generated which has to a great extent a real twist.

An arrangement of this type permits high spinning speeds, whereby high demands are also made above all on the drafting unit arranged upstream of the airjet unit. In particular, fiber fly tends to settle on the peripheral surfaces of the very rapidly rotating delivery roller pair. For this reason, the suction opening of a cleaning channel is arranged near the delivery roller pair of the known spinning arrangement, which cleaning channel ensures that the delivery roller pair is kept clean. The cleaning channel is arranged in the known manner toward to the top roller of the delivery roller pair and extends inside of the airjet unit into the evacuation channel. The evacuation channel is designed as a ring channel around a spindle-shaped stationary component in the mouthpiece area. Both channels are thus connected to a vacuum channel, which makes for a space-saving design.

Evacuation channels or tubes, in particular, do not need to be run through the area of the drafting unit, in which the top rollers, together with their loading devices, are located. As, for example, the top rollers can be raised from the bottom rollers in the case of an end break, suction devices in this area would make the design and the service of the arrangement extremely complicated.

In addition, the embodiment has the advantage that, for example, in the case of a necessary change of the airjet units for maintenance purposes, only one connecting piece need be removed from the airjet unit.

The known arrangement has, however, the disadvantage that the cleaning channel runs into the ring channel, which is designed in a ring-like manner around the spindle-like component. This ring channel serves to collect the air to be suctioned out of the vortex chamber and to guide it into the evacuation channel. The ring channel must therefore completely surround the spindle-shaped component in the form of a complete annular ring. On entering into the ring channel, the airstream, which streams out of the cleaning channel into the evacuation channel, together with the fibers and trash particles suctioned from the top roller, is divided into two separate airstreams by means of the spindle-shaped component located in the center. The two separate airstreams are guided past the spindle-shaped component on both sides thereof. Because of the division of the air stream, fibers can settle very easily around the spindle-shaped component and remain there. This can lead to an impairment of the spinning process, culminating in clogging of the ring channel and subsequently an end break.

It is an object of the present invention to improve an arrangement of the above mentioned type while retaining its cited advantages, in that the tendency to clog is reduced, thus increasing operational reliability and dependability.

This object has been achieved in accordance with the present invention in that the cleaning channel is only merged with the evacuation channel downstream of the ring channel in the airstream direction.

It has been shown that the clogging tendency of the cleaning channel and the air evacuation channel is reduced when the airstream is not divided into two separate streams. The fibers and trash particles transported in the airstream of the cleaning channel can be evacuated without difficulty when one defined path for the airstream is determined. This is achieved in that the air streaming from the vortex chamber into the evacuation channel is first collected in a ring channel and subsequently joined with the air from the cleaning channel in a channel area without obstructions and having a defined airstream.

It is, in particular for reasons of space, advantageous when the cleaning channel also includes a ring-shaped area, which is arranged around the spindle-shaped component. This ring-shaped area is, however, not connected to the ring channel and is not designed in cross section as a complete annular ring, but rather only as a section of an annular ring, so that the above described disadvantageous division of the airstream does not take place.

It is in addition advantageous to run the cleaning channel from the top roller as far as possible in the inside of the airjet unit, and to provide for the joining with the air evacuation channel inside the airjet unit. The airjet unit can thus be connected to the vacuum source by way of a single connecting piece, providing the facility for a simple dismantling of the airjet unit.

### BRIEF DESCRIPTION OF THE DRAWINGS

These and further objects, features and advantages of the present invention will become more readily apparent from the following detailed description thereof when taken in conjunction with the accompanying drawings wherein:

FIG. 1 shows an enlarged and schematic spinning unit in cross section;

FIG. 2 shows a drawing similar to FIG. 1 of a further embodiment of the channels in the spinning unit;

FIG. 3 shows a view of FIG. 1 along the intersectional surface III-III; and

FIG. 4 shows a view of FIG. 2 along the intersectional surface IV-IV.

### DETAILED DESCRIPTION OF THE DRAWINGS

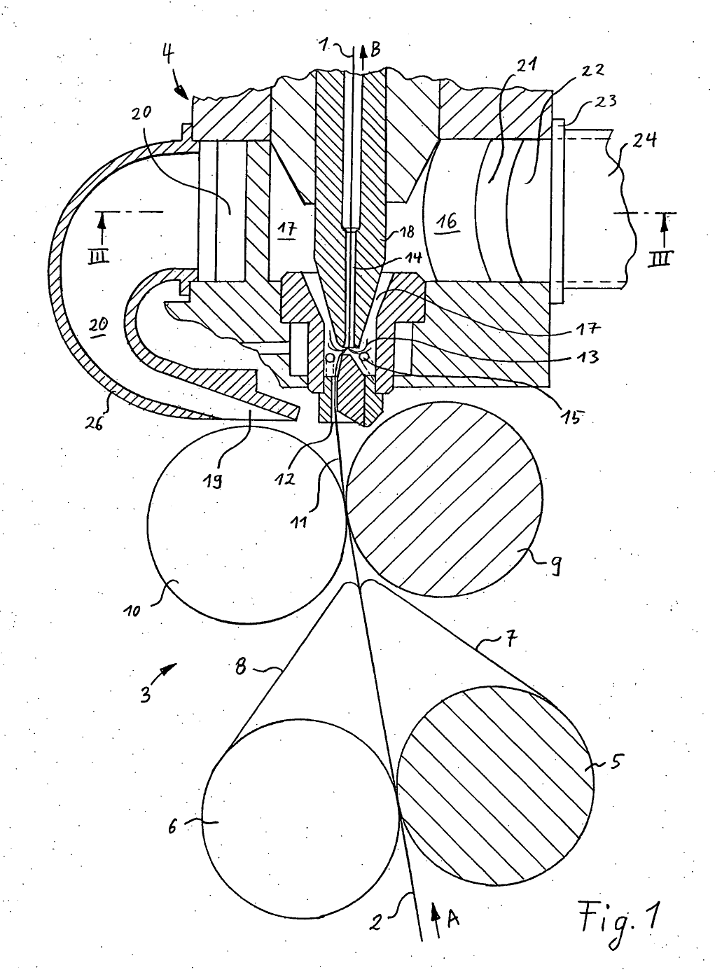

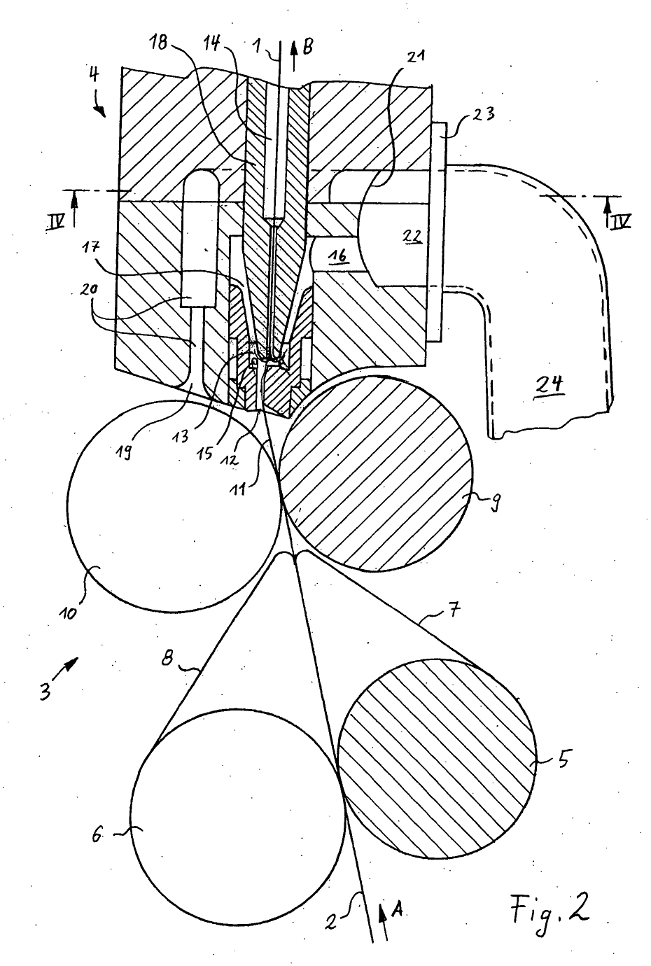

The arrangement shown in FIG. 1, as well as the variation shown in FIG. 2, serves to produce a spun thread 1 from a staple fiber strand 2. The arrangement includes as essential components a drafting unit 3 and an airjet unit 4.

The fiber strand 2 to be spun is fed to the drafting unit 3 in feed direction A and withdrawn as a spun thread 1 in delivery direction B and guided further to a winding device (not shown).

The only partly shown drafting unit 3 can be designed as a three or four cylinder drafting unit and includes a number of roller pairs, each of which comprises a driven bottom roller and an upper roller designed as a pressure roller. One or two roller pairs could, in the known way, be arranged upstream of the roller pair 5, 6 which is provided with guiding aprons 7 and 8. A delivery roller pair 9, 10 forms the exit of the drafting unit 3. The reference numbers 5 and 9 denote each driven bottom roller, while the reference numbers 6 and 10 denote the respective pressure rollers. In a drafting unit 3 of this type, the staple fiber strand 2 is drafted to a desired degree. Directly downstream of the drafting unit 3, a thin fiber strand 11 is formed, which is drafted, but still twist-free.

The design of the airjet unit 4, which is arranged downstream of the drafting unit 3 at a short distance thereto and which airjet unit 4 imparts the spinning twist, is optional in the case of the present invention, whereby, however, a design according to the International patent application WO 02/24993 is preferably mentioned, as an airjet unit 4 of this kind permits particularly high delivery speeds.

The fiber strand 11 is fed via an entry channel 12 to the airjet unit 4. Downstream thereof is a so-called vortex chamber 13, in which the spinning twist is imparted to the fiber strand 11, so that the spun thread 1 is formed, which is then withdrawn through a thread withdrawal channel 14. A fluid device generates, in the vortex chamber 13, a vortex current by blowing in compressed air through compressed air nozzles 15 which run tangentially into the vortex chamber 13. The compressed air exiting out of the nozzle openings 15 is discharged through an air evacuation channel 16, whereby the evacuation channel 16 is designed in its starting area as a ring channel 17 having a ring-shaped cross section around a spindle-shaped stationary component 18, which contains the thread withdrawal channel 14.

In the area of the vortex chamber 13, an edge of a fiber guiding surface is arranged as a twist block, which fiber guiding surface is arranged slightly eccentric to the thread withdrawal channel 14 in the area of its entry opening.

In the arrangement, the fibers to be spun are held on the one hand in the fiber strand 11 and guided in this state from the entry channel 12 essentially without twist into the thread withdrawal channel. On the other hand, the fibers in the area between the entry channel 12 and the yarn withdrawal channel 14 are subject to the action of the vortex current, which causes the fibers, or at least their end areas to be radially driven away from the entry opening of the thread withdrawal channel 14. As a result, the threads 1 produced by the described process show a core of fibers or fiber areas extending essentially in thread longitudinal direction without any significant twist, and an outer area in which the fiber or fiber areas are twined around the core.

This composition of fibers is formed, according to an idealized process for the purposes of greater clarity, in that the front ends of fibers, in particular those whose rear areas are still held upstream in the entry channel 12, essentially get into the thread withdrawal channel 14 directly, but that rear fiber ends, in particular when they are no longer held in the entry area of the opening channel 12, are pulled out of the fiber strand 11 by the vortex current and are then twined around the forming thread 1. In any case, fibers are simultaneously intertwined in the forming thread 1, which results in the fibers being pulled through the thread withdrawal channel 14, and subjected to the vortex current, which results in the fibers being centrifugally accelerated, that is, away from the entry opening of the thread withdrawal channel 14, and being withdrawn in the ring channel 17 at the start of the evacuation channel 16. The fiber areas pulled out of the fiber strand 1 due to the vortex current form a fiber vortex which runs into the entry opening of the thread withdrawal channel 14, the longer parts of the fiber vortex rotating outside on the spindle-shaped component 14 and being pulled against the force of the current in the ring channel 17 into the entry opening of the thread withdrawal channel 14.

An arrangement of this type permits particularly high spinning speeds, which can lie in the range of 600 m/min. It is obvious that very high demands are hereby made on the drafting unit 3, as the delivery roller pair 9, 10 must rotate very rapidly due to the necessary high drafting performance. This results inevitably in the delivery roller pair 9, 10, in particular the top roller 10, being subject to heavy fly accumulation caused by waste fibers. For this reason, a suction opening 19 of a cleaning channel 20 is arranged toward the pressure roller 10 of the delivery roller pair 9, 10.

In contrast to the above described prior art, the cleaning. channel 20 does not run into the ring channel 17. The cleaning channel 20 joins at its mouthpiece 21 the air evacuation channel 16, whereby the mouthpiece 21 is arranged in the air stream direction downstream of the area of the air evacuation channel 16 designed as a ring channel 17. This has the advantage that the air stream transporting the trash fibers and the dust out of the cleaning channel 20 is always guided on a defined path. A division of the air stream, as in the prior art, together with the above mentioned disadvantages, does not take place. This results in a reduced tendency of the air evacuation channel 16 to accumulate trash and to an increased operational reliability of the airjet unit.

Downstream of the mouthpiece 21 of the cleaning channel 20 in the air evacuation channel 16, a combined channel 22 is connected to a joint vacuum source 24 via a connecting element 23, which is shown in this case as a suction tube, but which advantageously leads to a fan (not shown). It is advantageous to arrange the mouthpiece 21 of the cleaning channel 20 in the air evacuation channel 16 in such a way that both channels can be connected by way of a joint connecting element 23 to the vacuum source 24, as this results in the surface to be sealed being minimized. This can occur particularly advantageously in that the cleaning channel 20 and the air evacuation channel 16 merge in the inside of the airjet unit 4.

It is in addition advantageous to arrange the connecting element 23 below the drafting field level on the side of the bottom rollers 5 and 9 of the arrangement. This ensures good access and easy operability of the airjet unit 4, which usually takes place from the side of the pressure rollers 6 and 10.

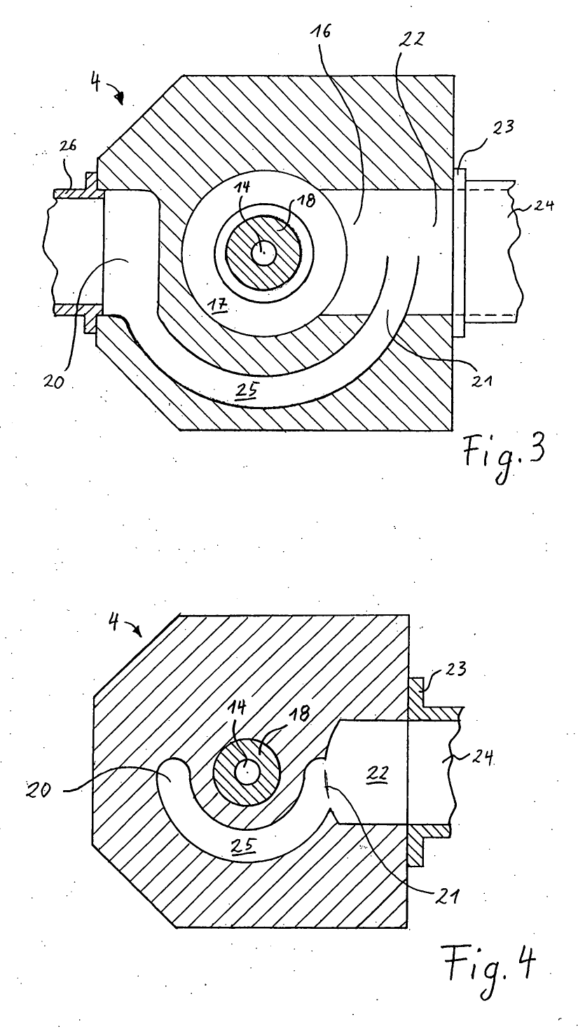

For connecting the suction opening 19 arranged near the pressure roller 10, it is advantageous to run the cleaning channel 20—as shown in FIGS. 3 and 4—through the airjet unit 4 in a ring-shaped area 25 around the spindle-shaped component 18. It can be provided hereby in accordance with the embodiments in FIGS. 1 and 3 that the ring-shaped area 25 is arranged concentrically around the ring channel 17. The separate running of the cleaning channel 20 around the spindle-shaped component 18 has the advantage that the spindle-shaped component 18 in the cleaning channel 20 no longer represents an “obstacle” for the fibers and trash particles transported in the air, as is the case in the above mentioned prior art. In this way, the air can transport the waste fiber away to a great extent without obstruction.

It can also be provided to optimize the effect of the suction opening 19 with the aid of a short connecting element 26 shown in FIG. 1 and by way of a suitable position in relation to the top roller 10. The connecting element 26 is advantageously to be placed in such a way that raising the top roller 10 from the bottom roller 9 when necessary is not hindered.

A further advantage of the described embodiment is that, in the case of a possible traversing of the airjet unit 4 transversely to the feed direction A, the suction opening 19 moves automatically with the airjet unit 4 and is always in the correct position.

In an embodiment of the present invention, a device, in a way not shown here but generally known, may be provided in the cleaning channel 20 or in the air evacuation channel 16, which can increase the low pressure prevailing at the suction opening 19 at intervals by the use of injector nozzles, in order, for example, to temporarily suck the fiber strand through the cleaning channel 20 during a piecing process.

What is claimed is:

1. An arrangement for producing a spun thread from a staple fiber strand, comprising:
a drafting unit having a delivery roller pair;
an airjet unit arranged downstream of the drafting unit; which airjet unit includes a vortex chamber having an air evacuation channel;
a cleaning channel having a suction opening arranged near the delivery roller pair;
wherein the air evacuation channel is designed at least in a primary section as a ring channel around a stationary spindle-shaped component; and
further wherein the cleaning channel merges with the air evacuation channel and are both connected to a common vacuum source, the cleaning channel only merging with the air evacuation channel downstream of the ring channel in an airstream direction.

2. The arrangement according to claim 1, wherein the cleaning channel comprises a ring-shaped area, which is arranged around the spindle-shaped component.

3. The arrangement according to claim 1, wherein the cleaning channel joins the air evacuation channel in an interior of the airjet unit.

4. The arrangement according to claim 2, wherein the cleaning channel joins the air evacuation channel in an interior of the airjet unit.

5. A cleaning channel arrangement of a spinning device having an airjet unit with an air evacuation channel formed with a ring-shaped channel component arranged around a stationary spindle thread withdrawal component, the cleaning channel arrangement comprising:
a cleaning channel having a suction opening operatively configured with respect to a drafting unit;
wherein the cleaning channel merges into the air evacuation channel downstream of the ring-shaped channel component in an airstream direction.

6. The cleaning channel arrangement according to claim 5, further comprising a common vacuum source coupled to the merged cleaning channel and air evacuation channel.

7. The cleaning channel arrangement according to claim 5, wherein a portion of the cleaning channel is formed with a partial ring-shape extending around the spindle-shaped thread withdrawal component.

8. The cleaning arrangement according to claim 5, wherein the cleaning channel merges with the air evacuation channel within the air jet unit.
